(19) United States
(12) Patent Application Publication
(10) Pub. No.: US 2011/0147519 A1
(43) Pub. Date: Jun. 23, 2011

(54) BRAKE DISC PACK FOR AIRCRAFT

(76) Inventor: Dennis SCOTT, Taunton (GB)

(21) Appl. No.: 12/720,091

(22) Filed: Mar. 9, 2010

(30) Foreign Application Priority Data
Dec. 18, 2009 (EP) EP 09015658.9

(51) Int. Cl. B64C 25/42

(52) U.S. Cl. 244/110 A

(57) ABSTRACT

An inert gas system is provided, particularly for aircrafts. The inert gas system comprises an inert gas reservoir, provided in a wing or a fuselage, for supplying inert gas to the at least one fuel tank. Inert gas is supplied via a piping system to at least one brake disc pack of at least one landing gear. Inert gas supplied generates an oxygen reduced atmosphere at the at least one brake disc pack.

This nonprovisional application claims priority under 35 U.S.C. §119(a) to European Patent Application No. EP 09015658.9, which was filed on Dec. 18, 2009, and which is herein incorporated by reference.

### BACKGROUND OF THE INVENTION

1. Field of the Invention

The invention relates to aircraft braking systems, particularly to aircraft braking systems comprising a brake disc pack of at least one brake disc. The brake discs of the brake disc pack can either be made from steel withstanding very high temperatures or from carbon fiber.

2. Description of the Background Art

Braking systems for aircraft either aircrafts for passenger transport or for the transport of cargo are either made from steel or carbon-fiber nowadays. As compared to steel-made brake discs, carbon fiber-made brake discs withstand higher temperatures. For this reason nowadays, the majority of aircraft brake systems, arranged at the bottom of the landing gear, are composite brake discs made from carbon-fiber.

Concerning the costs of operating commercially used passenger airplane or commercially used cargo airplane the costs for fuel are of major importance, followed by the costs for tires which are subject to wear upon each landing process of the aircraft, followed by the amount of costs involved with aircraft braking systems. As outlined above, braking systems for aircraft comprise either brake discs made from steel which only can by operated until a certain temperature above which they loose their braking effect or are being made from carbon-fiber, which is subject to mechanical wear.

Concerning the brake systems comprising generally laterally movable brake discs made from carbon fiber, the surfaces of each of the brake discs arranged within a brake disc pack are exposed to an oxygen atmosphere. It has to be understood, that oxygen atmosphere means the ambient atmosphere, i.e. the surrounding air having a percentage of 21% of oxygen.

On the respective surfaces of the carbon-made brake discs the presence of oxygen in the surrounding generates a layer which is eroded from the surfaces upon each landing process. This in turn has the consequence that the thickness of the carbon-made brake discs decreases gradually upon the operation of the airplane, until a minimum thickness has been reached and an exchange of the respective brake disc of the brake disc pack or the exchange of the entire brake disc pack becomes necessary.

Brake discs made from carbon fiber in commercial operation usually withstand about 2000 landings before their thickness has reached a critical value, which in turn triggers the exchange of the respective brake disc or the entire brake disc pack.

### SUMMARY OF THE INVENTION

It is therefore an object of the present invention to provide a brake system including a brake disc pack, the single brake discs being made of carbon fiber, in which the wear of the brake discs of the brake disc pack is reduced significantly.

According to an embodiment of the present invention an oxygen-depleted gas, or oxygen-depleted air or an inert gas is supplied to the landing gear of the aircraft, particularly to the area in which the brake disc pack or brake disc arrangement is located. This offers the advantage that an inert gas system already being present in the aircraft, particularly to supply inert gas or oxygen-depleted gas, or oxygen-depleted air to a fuel tank or a fuel tank system in the wing is used as a source of a gas creating an oxygen reduced atmosphere to be supplied to the braking system of the aircraft. In commercially used aircrafts, either passenger aircrafts or cargo aircrafts, either in one of the wings or in a compartment of the fuselage an inert gas reservoir is present. By means of this inert gas reservoir, inert gas or oxygen-depleted gas, or oxygen-depleted air is provided via an inert gas wing piping system to the number of fuel tanks, commonly arranged in the interior of the wings of the aircraft.

In an embodiment of the present invention the inert gas reservoir supplies inert gas or oxygen-depleted gas, or oxygen-depleted air via an inert gas supply line to a valve, particularly a 3-way-valve. This valve is actuated upon landing such that inert gas or oxygen-depleted gas, or oxygen-depleted air is not supplied to the fuel tanks only but as well to a piping system in the landing gear of the aircraft. The piping system, in which the inert gas, oxygen-depleted gas or oxygen-depleted air is conveyed, comprises a bypass having a throttle element which bypasses the valve particularly a 3-way-valve of the inert gas piping system. Alternatively, two one-way valves are conceivable to allow for a simultaneous supply of an oxygen-depleted gas, oxygen-depleted air or an inert gas to the fuel tanks as well as to the landing gear.

The inert gas system for supplying inert gas, oxygen-depleted gas, or oxygen-depleted air to the braking system of the aircraft can comprise at least one vertical pipe arranged within the landing gear. The at least one vertically extending pipe extending through to the landing gear communicates with at least one horizontal pipe of the landing gear. The horizontal pipe may be the axle of the landing gear on which the tyres of the landing gear are mounted, surrounding the brake systems of the aircraft. The vertically arranged pipe within the landing gear of the aircraft may communicate in a very advantageous embodiment with the axle in the centre thereof to supply inert gas to both sections of the axle. The axle comprises a hollow interior which forms a duct for extending in horizontal direction for the inert gas.

On the axle a brake saddle being is mounted stationarily arranged and a number of brake discs made from carbon fiber. By means of a piston arrangement, the brake disc assembly of the brake disc pack is movable in axial direction. This may include an electrical or in the alternative an hydraulically actuation of the piston arrangement for actuating the brake disc assembly.

In the deactivated stage of the braking system of the aircraft the number of brake discs of the brake disc pack is arranged so as to form annular spaces between adjacently arranged brake discs. Openings in the circumference of the axle of the landing gear are arranged such that they correspond to the annular spaces extending between the surfaces of adjacently arranged brake discs. Upon activation of the brake system according to the present invention, a flow of inert gas, or oxygen-depleted gas or oxygen-depleted air is effected by means of the piping system upon activation of the valve, inert gas or oxygen-depleted gas, or oxygen-depleted air flowing through the at least one vertically extending pipe in communication with the hollow interior of the axle and flowing into the annular spaces between the surfaces of the number of the brake disc pack. By means of this an oxygen reduced atmosphere is created in the brake disc pack, particularly in those spaces in which the surfaces of the number of brake discs contact each other upon the braking process. The layer subject to wear and created by the ambient oxygen atmosphere is reduced significantly, so that the brake disc pack or the single brake discs, respectively according to the brake system of the present invention lasts longer than 2000 landings. The reason for that is that upon elimination of the oxygen created layer on the surfaces of each of the brake discs their respective thickness will not decrease so fast as compared to the solutions according to previous solutions.

The piston arrangement for moving the braked discs laterally is either been activated electrically or hydraulically.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of an aircraft having an activated landing gear;

FIG. 2 shows parts of the inert gas system according to an embodiment of the present invention in an area of the brake disc pack in the landing gear;

FIG. 3 schematically shows the inert gas piping system, with a 3-way-valve;

FIG. 3.1 shows an inert gas piping system having two independent 1-way-valves;

FIG. 4 shows the interior of the axle of the landing gear with openings arranged on the circumference; and

FIG. 5 shows in a schematical view the arrangement of the inert gas reservoir within the wing, the arrangement of fuel tanks and the position of the landing gear.

### DETAILED DESCRIPTION

In connection with the present invention an inert gas is a gaseous medium, which is either not able to react, i.e. such as nitrogen or the reactivity of which is reduced significantly. Besides an inert gas, an oxygen-depleted gas or oxygen-depleted air can be used as well.

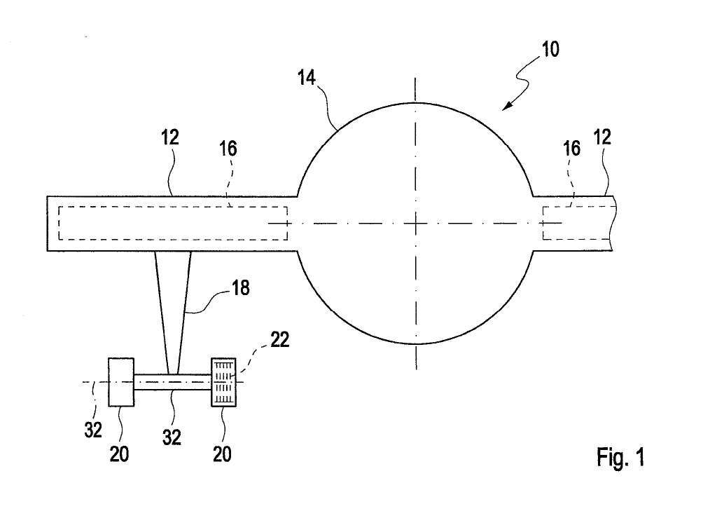

FIG. 1 shows a schematical view of an aircraft either a commercially uses passenger aircraft or a commercially cargo aircraft.

An aircraft 10 comprises wings 12 which are mounted on a fuselage 14. Within the wings 12 at least one fuel tank 16 is arranged. According to FIG. 1 a landing gear 18 comprises an axle 32, being contacted by the landing gear 18 in the centre of thereof. To the axle 32 in general a pair of tires 20 is assigned, the tires 20 each surrounding brake discs 22. The tires 20 are subject to wear as well as the number of brake discs 22 assigned to the landing gear 18.

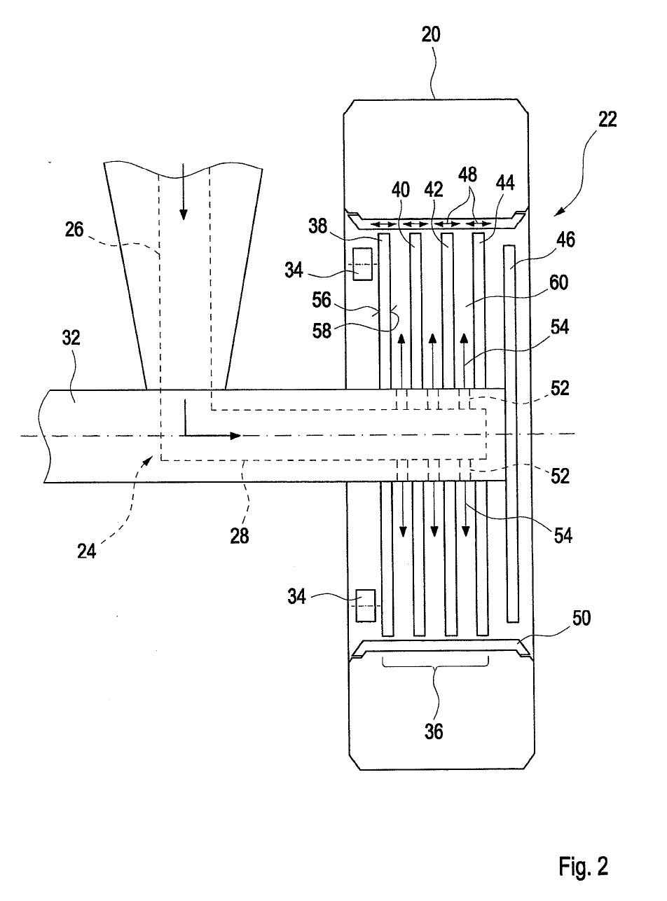

FIG. 2 shows the brake discs according to FIG. 1 in greater detail and in a larger scale.

According to FIG. 2 the landing gear 18 is fixed to the axle 32 in the centre thereof. On the circumference of the axle 32 a brake disc pack 36 is arranged. The brake disc pack 36 comprises a number of single brake discs 38, 40, 42 and 44, respectively. Reference number 38 depicts a first brake disc, reference number 40 depicts a second brake disc, reference number 42 depicts a third brake disc and reference number 44 depicts a fourth brake disc. Each of the brake discs 38, 40, 42, 44 is made of carbon fiber material or comprises carbon fiber material. Further, the brake disc pack 36 according to FIG. 2 comprises a stationarily mounted brake saddle 46. The brake saddle 46 is mounted on the axle 32 in a stationary manner. According to FIG. 2 each of the discs 38, 40, 42 and 44, respectively, is movable in lateral direction as depicted by arrows labelled reference number 48. The lateral movement 48 of each of the brake discs 38, 40, 42 and 44, respectively, is affected by a piston assembly 34 being actuated electrically or hydraulically. Each of the pistons of the piston assembly 34 is mounted on a spoke-like arrangement in circumferential direction to compress the brake discs 38, 40, 42 and 44, respectively, in lateral direction as depicted by the double arrows 48, indicating the lateral movement of the brake discs 38, 40, 42 and 44, respectively.

On the circumference of a rim 50 a tire 20 is mounted.

According to the embodiment given in FIG. 2 the landing gear 18 comprises a vertical pipe 26 of an inert gas system 24. A at least one vertical pipe 26 is mounted within the landing gear 18. A at least one vertical pipe 26 is connected to at least two horizontal pipes 28 which extend to the horizontal direction through the axle 32 as given in FIG. 2. The at least one vertical pipe 26 and the horizontal pipe 28 are part of an inert gas pipe system 24 connected to an inert gas tank which is not shown in FIG. 1 and FIG. 2, respectively.

Inert gas, such as nitrogen, or an oxygen-depleted gas or oxygen-depleted air is supplied by means of the at least one vertical pipe 26 to the horizontal pipe 28 imbedded in the axle 32. Through the hollow interior of the axle 32 depicted in FIG. 2, inert gas, or oxygen-depleted gas or oxygen-depleted air is supplied to openings 52 arranged on the circumference of the axle 32. The location—in axial direction—on the openings 52 in the circumference area of the axle 32 corresponds to annular spaces 60 between surfaces 56, 58, respectively, of adjacent brake discs 38, 40, 42, 44, respectively.

As shown in FIG. 2 inert gas, or oxygen-depleted gas, or oxygen-depleted air passing the at least one vertical pipe 26 within the landing gear 18 is fed to the horizontal pipe 28 arranged within the axle 32. The inert gas, or oxygen-depleted gas, or oxygen-depleted air exits the hollow interior of the axle 32 on the openings 52 in the circumference of the axle 32 and is sprayed into the annular spaces 60, see reference number 54 showing the inert gas flow or a flow of an oxygen-depleted gas or a flow of oxygen-depleted air. By the flow of either inert gas or oxygen-depleted gas, or oxygen-depleted air 54 to the surfaces 56, 58, respectively, each of the brake discs 38, 40, 42 and 44 are surrounded by an oxygen-reduced atmosphere. An oxidized layer of carbon fiber created by oxygen of the ambient atmosphere is significantly eliminated such that the thickness of each of the brake disks 38, 40, 42 and 44, respectively of the brake disc pack 36 decreases gradually over longer operating time. Rather, the surfaces 56, 58, respectively, of each of the brake discs 38, 40, 42 and 44, respectively is exposed to an oxygen reduced, i.e. nitrogen enriched atmosphere. In according to FIG. 2 the annular spaces 60 each are surrounded by surfaces 56, 58, respectively of adjacently mounted brake discs 38, 40, 42 and 44. Still further the annular space 60 is limited by the bottom of the rim 50 the inert gas such as nitrogen being fed via openings 52 in the axle 32 in substantially radial direction is kept within the annular spaces 60 and a oxidisation of surfaces 56, 58 of the brake discs 38, 40, 42, 44 is reduced significantly. In view of the solution according to the present invention, the number of landings to be preformed with a brake disc pack being exposed to an oxygen reduced atmosphere is increased up to 2500 to 3000 landings. The sustainability of the brake discs 38, 40, 42 and 44, respectively, is increased significantly by the implementation of the present invention.

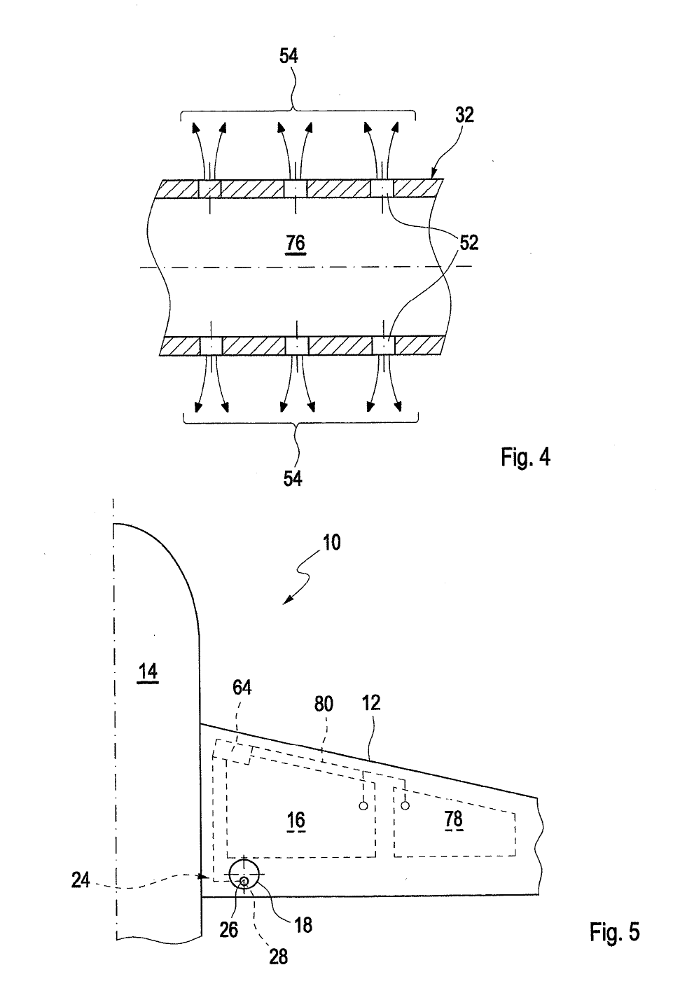

In FIG. 2 it is shown that the openings 52 in the axle 32 correspond to the annular spaces 60 between each of adjacently mounted brake discs 38, 40, 42, 44, respectively. As shown in FIG. 2, an opening 52 could be provided on the side of first surface 56 of brake the first brake disc 38. Thus, inert gas or oxygen-depleted gas, or oxygen-depleted air would be directed to the first surface 56 of the first brake disc 38 which is arranged opposite to the piston arrangement 34. Likewise an opening 52 in the axle 32 in the area between the second surface 58 of the fourth braked disc 44 facing the stationarily mounted brake saddle 46 is conceivable. In FIG. 2 is shown that the landing gear 18 comprises the one vertical pipe 26 which in this embodiment feeds a vertical pipe 28 or a hollow interior 76 of the axle 32 as shown in FIG. 4.

In the embodiment given in FIG. 2 the at least on vertical pipe 26 extending through the landing gear 18 just feeds one horizontal pipe 28. Given the landing gear 18 according to FIG. 1, the vertical pipe 26 may feed two horizontally extending pipes 28 arranged inside the axle 32 at the same time. For this purpose the vertical pipe 26 is mounted to the axle 32 of a landing gear 18 essentially in the centre thereof.

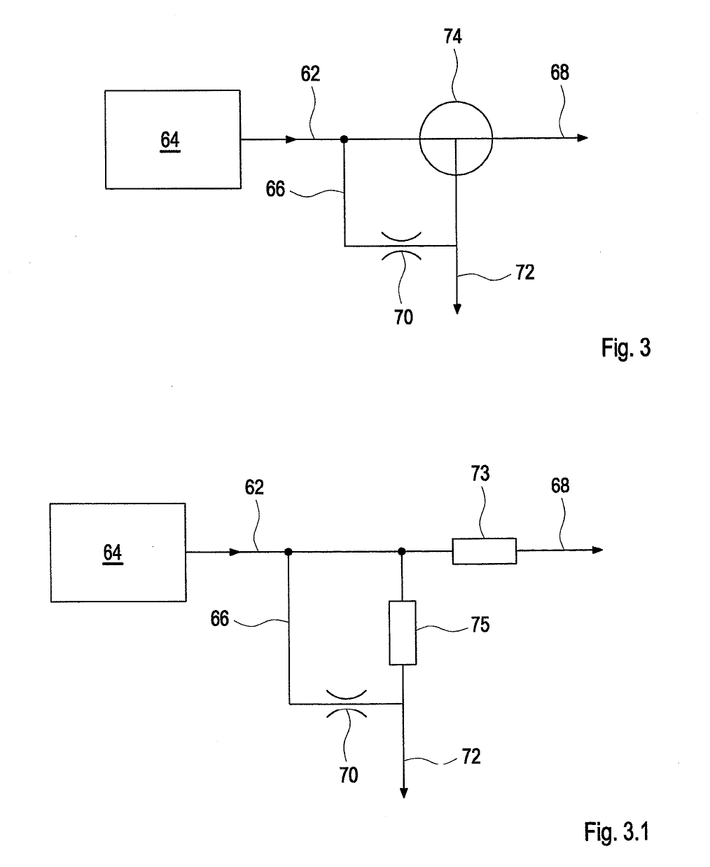

FIG. 3 shows the major components of the inert gas system according to the present invention.

At least one inert gas reservoir 64 is mounted in the interior of the wings 12 of an aircraft 10 or in the interior of the fuselage 14 of the aircraft 10. Within the at least one inert gas reservoir 64 alternatively, the previously mentioned oxygen-depleted gas or oxygen-depleted air may be stored as well and supplied to the inert gas pipe system 24 accordingly.

Via an inert gas supply 62 inert gas such as nitrogen is fed to a 3-way-valve 74. A bypass 66 having a throttle element 70 is arranged in direction of the flow of inert gas or oxygen-depleted gas, or oxygen-depleted air via the entry of the 3-way-valve 74 as shown in FIG. 3. The bypass 66 allows to feed inert gas or oxygen-depleted gas, or oxygen-depleted air via bypass 66 at an ambient pressure which depends on the dimensioning of the throttle 70 directly to a supply 72 extending to the brake disc pack and being fitted to the at least one vertical pipe 26 as shown in FIG. 2. Upon actuation of the 3-way-valve inert gas is either directed via supply 68 to at least one fuel tank 16, 78 arranged within the wings and/or to the supply 72 to the brake disc pack 36 of the landing gear 18. Via bypass 66 a constant supply of inert gas or oxygen-depleted gas, or oxygen-depleted air to the brake disc pack is visible via supply 72 to the brake disc pack as schematically shown in FIG. 2, being described below.

In FIG. 3 just one inert gas reservoir is shown, two or more inert gas reservoirs 74 may be arranged in the fuselage 14 or the wings 12 of the airplane to ensure a supply of inert gas or oxygen-depleted gas, or oxygen-depleted air to fuel tank 16, 78 and the landing gears 18, respectively.

FIG. 3.1 shows an inert gas tank reservoir from which by means of an inert gas supply 62 inert gas, or oxygen-depleted gas or oxygen-reduced air is supplied to an arrangement of a first 1-way-valve 73 and a second 1-way-valve 75. The first 1-way-valve 73 is assigned to the supply 68 to the at least one fuel tank, whereas the second valve 75 is arranged within the supply 72 to the brake disc pack 36 not shown in greater details in the schematic embodiments according to FIGS. 3 and 3.1, respectively. Instead of the 3-way-valve 74 used in the embodiment according to FIG. 3, FIG. 3.1 makes use of two independently actuatable 1-way-valves 73, 75, respectively. This allows for an simultaneously supply of an inert gas, or an oxygen-depleted gas or oxygen-depleted air to both systems, i.e. the fuel tank as well as the landing in the at least fuel tank 16 as well as to the landing gear 18.

FIG. 4 shows schematically an axle of the landing gear having a hollow interior.

In a further embodiment of the present invention, a hollow interior 76 of the axle 32 may be used as horizontal pipe 28. As shown in FIG. 4, openings 52 are manufactured on the circumference of the axle 32 serving the purpose to supply an flow 54 of either inert gas or oxygen-depleted gas or oxygen-depleted air into the annular spaces 60 as best shown in FIG. 2. The annular space 60 serve as a kind of cage and keep the inert gas or oxygen-depleted gas, or oxygen-depleted air present at the surfaces 56, 58, respectively of adjacently mounted brake discs 38, 40, 42 and 44, respectively. The solution according to FIG. 4 eliminates the need of horizontal pipe 28 extending through the hollow interior 76 of that axle 32 according to FIGS. 1 and 2, respectively. The flow 54 of inert gas, oxygen-depleted gas or oxygen-depleted air extends in radial direction and may be directed by an inclination of the openings 52 towards that surfaces 56 and 58 of the brake discs or essentially in radial direction. Thus, a constant flow 54 of inert gas, oxygen-depleted gas, or oxygen-depleted air into the annular spaces 60 as best shown in FIG. 2 is ensured to prevent oxidization of the surfaces 56, 58 of each of the brake discs 38, 40, 42 and 44 of the brake disc pack 36.

FIG. 5 shows a top view of a wing of an aircraft and parts of its fuselage.

According to FIG. 5 the aircraft 10 is supplied with a wing 12 in which at least one fuel tank 16 is arranged. Within the wing 12 according to FIG. 5, a further fuel tank 78 may be arranged. Both fuel tanks 16 and 78, respectively, are being fed by inert gas or oxygen-depleted gas, or oxygen-depleted air via an inert gas wing piping system 80. The inert gas piping system 80 is connected to the inert gas reservoir 64 arranged closer to the fuselage 14 and supplies inert gas or oxygen-depleted gas, or oxygen-depleted air to the fuel tank 16, 78.

The inert gas reservoir 64 arranged in the wing 12 shown in FIG. 5 is arranged on the left wing of the aircraft 10—not shown in greater detail in FIG. 5.

Still further, the inert gas reservoir 64 according to FIG. 5 does not only supply inert gas or oxygen-depleted gas, or oxygen-depleted air to the inert gas piping system 80 but also to an inert gas pipe system 24 which supplies inert gas or oxygen-depleted gas, or oxygen-depleted air to the brake disc pack 36 at the bottom of the landing gear 18. Via the inert gas pipe system 24 the inert gas reservoir 64 is connected to the at least vertical pipe 26 extending in a substantially vertical direction through the landing gear 18. It is connected either to the horizontal pipe 28 feeding inert gas or oxygen-depleted gas, or oxygen-depleted air to the brake disc pack of the tyres 20, or the hollow interior 76 of the axle 32 at the bottom of the landing gear 18 as shown in FIG. 4.

The inert gas pipe system 24 being fed by the inert gas reservoir 64 arranged with in the wing 12 is active on landings and is being activated simultaneously with the activation of the piston arrangement 34 to generate a lateral movement 58 of that brake discs 38, 40, 42, 44 of the brake disc pack 36.

In connection with the present invention an suitable inert gas is nitrogen however, other inert gases are suitable as well. Alternatively to an inert gas such as nitrogen, an oxygen-depleted gas or oxygen-reduced air might be used well as medium conveyed within an inert gas pipe system 24 according to the present invention. Inert gas wing piping systems 80 is connected to the fuel tank 16 and a further fuel tank 78 arranged in the wing 12, may be operated independently from the inert gas pipe system 24 as well as inert gas to the brake disc pack 36. The inert gas pipe system 24 as well as the inert gas wing piping system 80 shown in the wing 12 on the right-hand side of the fuselage 14 is arranged within the left-hand wing 12 of the aircraft 10 schematically shown in FIG. 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An inert gas system for an aircraft, the system comprising at least one inert gas reservoir configured to provide an oxygen-depleted gas, wherein the oxygen-depleted gas is configured to be provided to at least one brake disc pack of at least one landing gear to create an oxygen reduced atmosphere at the at least one brake disc pack.

2. The inert gas system according to claim 1, wherein the at least on brake disc pack comprises a plurality of brake discs made from carbon fiber or comprising carbon fiber material.

3. The inert gas system according to claim 1, wherein the at least brake disc pack comprises a stationarily mounted brake saddle.

4. The inert gas system according to claim 2, wherein the brake discs are movable laterally.

5. The inert gas system according to claim 2, wherein the brake are movable laterally via a piston arrangement.

6. The inert gas system according to claim 5, wherein the piston arrangement is actuated electrically or hydraulically.

7. The inert gas system according to claim 2, wherein, in a non-activated stage of the brake disc, annular spaces are formed between adjacently mounted brake discs.

8. The inert gas system according to claim 1, wherein, in the at least one inert gas reservoir, an oxygen-depleted gas or oxygen-depleted air or an inert gas is provided for supplying an gaseous medium to the inert gas pipe system.

9. The inert gas system according to claim 1, wherein a valve is assigned to a flow path of the inert gas.

10. The inert gas system according to claim 1, wherein a piping system that comprises an inert gas supply, supplies inert gas to a vertical pipe arranged within the landing gear.

11. The inert gas system according to claim 1, wherein a piping system includes a horizontally extending pipe section within a hollow interior of an axle of the at least one landing gear.

12. The inert gas system according to claim 9, wherein the flow path of the inert gas comprises a bypass configured to bypass the valve.

13. The inert gas system according to claim 7, wherein the axle includes a plurality of openings assigned to the annular spaces between the brake discs.

14. The inert gas system according to claim 1, wherein an inert gas flow from the openings into the annular spaces is directed towards surfaces, respectively, of the brake discs.

15. The inert gas system according to claim 12, wherein the bypass comprises a throttle element.

16. The inert gas system according to claim 12, wherein the bypass extends from an inert gas supply line configured to supply the brake disc pack.

17. The inert gas system according to claim 1, wherein inert gas is fed by at least one vertical pipe directly to a hollow interior of the axle.

18. The inert gas system according to claim 1 wherein a horizontally extending pipe or the axle comprises openings on a circumference to direct an inert gas flow between the piston arrangement and the first brake disc and/or between the surface of this brake saddle and the second surface of the fourth brake disc.
